(19) United States
(12) Patent Application Publication
(10) Pub. No.: US 2024/0286940 A1
(43) Pub. Date: Aug. 29, 2024

(54) APPARATUS AND METHOD FOR REMOVING NITROGEN POLLUTION FROM WATER

(71) Applicant: Eutrobac LLC, Washington, CT (US)

(72) Inventors: Eleanor Catherine Sangree, Washington, MA (US); Jesse Raymond Wexler, New York, NY (US)

(21) Appl. No.: 18/590,805

(22) Filed: Feb. 28, 2024

Related U.S. Application Data
(60) Provisional application No. 63/448,855, filed on Feb. 28, 2023.

(51) Int. Cl. C02F 3/30; C02F 101/16

(52) U.S. Cl. CPC C02F 3/302; C02F 2101/16; C02F 2201/009; C02F 2203/006; C02F 2203/008

(57) ABSTRACT

An apparatus and method are provided for removing nitrogen pollution from a body of water. The apparatus includes a platform configured to be released into and float on the body of water, the platform including a confinement area. A pump is connected to the platform, with the pump being configured to pump water into the confinement area during a first period, and the pump being configured to not pump water into the confinement area during a second period. A drain is positioned in the platform configured to intermittently release water out of the confinement area. A substrate is provided in the confinement area, with the substrate being configured to allow for the formation of a biofilm on the substrate. The pump and drain are configured such that during the first period, water is moved into the confinement area by the pump and out of the confinement area through the drain, and the formed biofilm performs nitrification to convert at least one of ammonia and ammonium in the water into nitrite and nitrate. The pump and the drawing are also configured such that during the second period, water is stagnant in the confinement area and the formed biofilm converts the nitrite and nitrate into gaseous nitrogen.

### BACKGROUND

### Field of the Invention

Embodiments of the invention relate to an apparatus and method for removing nitrogen pollution from a body of water.

### Related Art

Nitrogen pollution in water bodies has led to dramatic increases in eutrophication and an associated loss of biodiversity. Nitrogen pollution arises from various sources, such as agricultural runoff, industrial discharge, and wastewater treatment plants. Agricultural activities, particularly involving the use of nitrogen-based fertilizers, contribute significantly to nitrogen loading in aquatic ecosystems. Surface runoff carries these nitrogen compounds to aquatic systems, where they accumulate and disrupt the natural balance of nutrient cycles. Similarly, urban and industrial areas release nitrogen through stormwater runoff and direct discharge into nearby aquatic systems, further exacerbating the issue. Excess nitrogen disrupts water bodies' capacity to effectively process nutrients, leading to eutrophication, algal blooms, and a decline in water quality.

The detrimental effects of nitrogen pollution in aquatic systems are many. Eutrophication resulting from excessive nitrogen input can lead to oxygen depletion in water bodies, harming aquatic organisms such as fish and amphibians. Algal blooms fueled by nitrogen pollution not only reduce biodiversity by shading out other plant species but also produce toxins harmful to wildlife and humans. Moreover, nitrogen pollution can alter the composition of aquatic plant communities, favoring fast-growing species over those adapted to lower nutrient levels, thereby disrupting the delicate balance of the ecosystem. Additionally, nitrogen pollution in aquatic systems can have far-reaching impacts beyond the immediate ecosystem, as contaminated water may flow downstream, affecting larger water bodies and coastal areas, exacerbating issues like hypoxia and dead zones in freshwater, estuaries, and the ocean.

To address nitrogen pollution, structures such as engineered wetlands have been used. Such structures are designed to promote denitrification, a process where bacteria convert nitrate into nitrogen gas, thereby removing nitrogen from water. Examples of structures can be seen in U.S. Pat. Nos. 6,652,743; 6,630,067; and 7,214,317, all of which are incorporated by reference herein in their entirety. Generally speaking, the prior art structures are permanent fixtures, immovably situated, and composed of several bulky components. As such, the prior art nitrogen pollution removal devices are not easily deployed, and once set in a body of water, cannot be moved.

### SUMMARY OF THE INVENTION

According to one embodiment, a device is provided for removal of nitrogen pollution from a body of water. The device includes a platform configured to be released into and float on the body of water, with the platform including a confinement area that is at least partially open at a top side of the device when the device is floating on the body of water. A pump is connected to the platform, with the pump being configured to pump water into the confinement area during a first period, and the pump being configured to not pump water into the confinement area during a second period. A drain is positioned in the platform and configured to intermittently release water out of the confinement area. A substrate is provided in the confinement area, the substrate being configured to allow for the formation of a biofilm on the substrate. The pump and drain are configured such that during the first period, water is moved into the confinement area by the pump and out of the confinement area through the drain, and the formed biofilm performs nitrification to convert at least one of ammonium and ammonia in the water into nitrite and nitrate. The pump and drain are also configured such that during the second period, water is stagnant in the confinement area and the formed biofilm converts the nitrite and nitrate into gaseous nitrogen via denitrification.

According to another embodiment, a method is provided for removing nitrogen pollution from a body of water. The method comprising releasing a floating device on the body of water, pumping water from the body of water into the floating device during a first period, draining water from the floating device during the first period, and allowing a water to stagnate in the floating device during a second period. During the first period, a biofilm in the device performs nitrification to convert at least one of ammonia and ammonium in the water into nitrite and nitrate. During the second period, the biofilm converts the nitrite and nitrate into gaseous nitrogen.

According to a further embodiment, a device is provided for removing nitrogen pollution from a body of water. The device includes a platform configured to be released into and float on the body of water, and the platform includes a confinement area that is at least partially open at a top side of the device when the device is floating on the body of water. A pump is connected to the platform, with the pump being configured to pump water into the confinement area during a first period, and the pump being configured to not pump water into the confinement area during a second period. A drain is positioned in the platform and configured to intermittently release water out of the confinement area. A substrate is provided in the confinement area, with the substrate being configured to allow for the formation of a biofilm on the substrate. The pump and drain are configured such that during the first period, water is moved into the confinement area by the pump and out of the confinement area through the drain. The pump and drain are also configured such that during the second period, water is stagnant in the confinement area and the formed biofilm converts nitrite and nitrate in the stagnant water into gaseous nitrogen via denitrification.

According to another embodiment, a device is provided for removing nitrogen pollution from a body of water. The device includes a platform configured to be released into and float on the body of water, the platform including a confinement area that is at least partially open at a top side of the device when the device is floating on the body of water. A pump is connected to the platform, with the pump being configured to pump water into the confinement area during a first period, and the pump being configured to not pump water into the confinement area during a second period. A drain is positioned in the platform and configured to intermittently release water out of the confinement area. A substrate is provided in the confinement area, with the substrate being configured to allow for the formation of a biofilm on the substrate. The pump and drain are configured such that during the first period, water is moved into the confinement area by the pump and out of the confinement area through the drain, and the formed biofilm performs nitrification to convert at least one of ammonium and ammonia in the water into nitrite and nitrate.

### BRIEF DESCRIPTION OF THE DRAWINGS

FIG. 1 is a schematic diagram of a device according to embodiment of the invention.

FIG. 2 is a flow chart showing a method according to an embodiment of the invention.

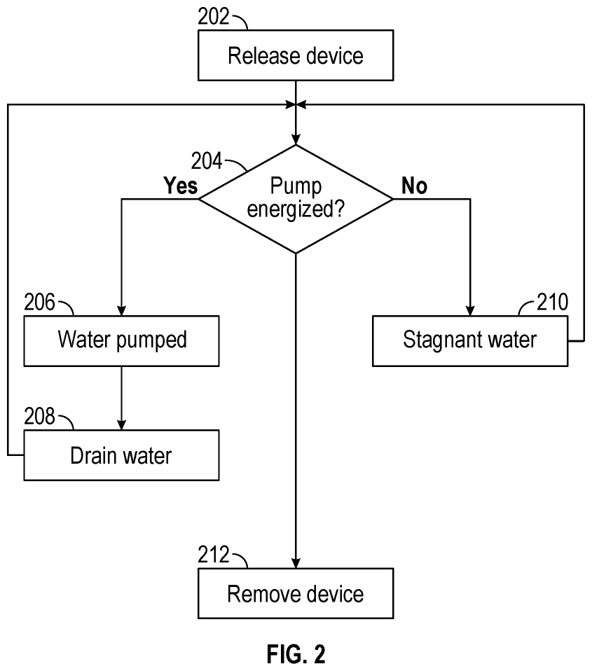

### DETAILED DESCRIPTION OF THE INVENTION

Embodiments of the invention will now be described. The embodiments relate to an apparatus and method for removing nitrogen pollution from a body of water. In some embodiments, the apparatus and method remove nitrogen pollution in water through a nitrification and/or a denitrification process that results in dissolved nitrogen species, such as ammonia, ammonium, nitrate, and nitrite pollutants being converted into gaseous nitrogen. In other embodiments, the apparatus and method remove nitrogen pollution in water through a nitrification process that results in ammonia and ammonium being converted into nitrate and nitrite.

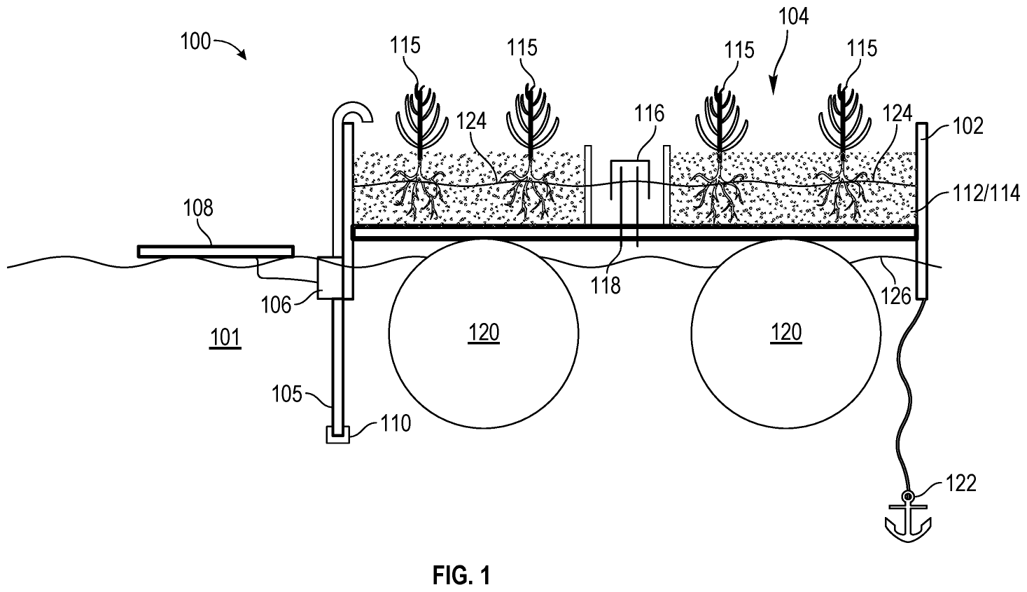

FIG. 1 is a schematic diagram of a device 100 according to an embodiment of the invention. As will be described below, the device 100 acts as a biofilter for removing nitrogen pollution from a body of water 101 (e.g., a lake, pond, or stormwater retention site). As will also be evident from the disclosure herein, the device 100 can easily be released into and removed from the body of water 101. Prior art devices for removing nitrogen water pollution often contain structures that are permanently fixed to a specific location in a body of water. Unlike that prior art, the device 100 is much more flexible in that it can be easily deployed in a body of water, positioned at different places in a body of water at different times, removed from the body of water for service, storage, moved to different bodies of water, etc.

The device 100 includes a platform 102 that may be constructed from a variety of materials, examples of which include molded plastics and wood. The platform 102 includes a confinement area 104 in which aspects of the invention are provided, as will be described below. In the depicted embodiment, the confinement area 104 is open at its topside when the device is floating in the body of water 101, i.e., open to the sky above the device 100. In other embodiments it is possible for the confinement area 104 to be partially covered at its topside.

Empty drums 120 are positioned on the lower side of the device 100 to provide the buoyancy that causes the device 100 to float on the water body 101. In a specific embodiment, the drums 120 each have a 55-gallon capacity. There are numerous alternatives to the drums 120 that could provide the buoyancy for the device 100. For example, in another embodiment of the invention, the lower side of the platform 102 could be configured to provide the buoyancy, e.g., by making a shape of the lower side of the platform such that a weight of water is displaced by the platform is greater than the weight of the device 100 (i.e., following Archimedes' Principle). Those skilled in the art will recognize several alternative designs and structures that could be used to provide buoyancy to the device 100.

FIG. 1 shows the placement of the device 100 in the body of water 101. The device 100 is configured such that the confinement area 104 of the platform 102 is raised above the water level 126. As such, water flows into and out of the device 100 only through the pump 106 and drain 116 systems (described below). The device 100 also includes an anchor 122 that may be deployed to fix the position of the device 100 at a specific location in the body of water 101.

Provided within the confinement area 104 are a substrate 112, plants 115, and the drain 116. The functions of each of these features will be described.

The substrate 112 is such that a biofilm 114 forms on the substrate 112 when the device 100 is released into the body of water 101. The formed biofilm 114 includes a community of bacteria that performs a process in which nitrogen pollution in the form of dissolved nitrogen species including ammonia (NH₃), ammonium (NH₄⁺), nitrate (NO₃⁻), and/or nitrite (NO₂⁻) are removed from the body of water 101. The biofilm performs the process in two steps, with a nitrification step first occurring in which the ammonia and ammonium are converted to nitrite and nitrate in an aerobic process. The second step is a denitrification step in which the nitrite and nitrate are converted into gaseous nitrogen (N₂) and water, with the second step generally occurring under anerobic conditions. Heterotrophic biological activity is spurred during the daytime as oxygen, organic carbon, and nutrients flood the system. As described below, the pump 106 of the device 100 periodically shuts off and the water in the device 100 becomes stagnant, and the bacteria in the biofilm 114 perform cellular respiration and/or nitrification, which as aerobic processes, consume dissolved oxygen in the system. This leads to the anaerobic environment in which denitrification can proceed. Thus, there is a “coupling” of nitrification to denitrification, as the environment inside the device becomes anaerobic quickly, thereby making denitrification favorable to proceed. Additionally, it is believed that the substrate (e.g., LECA) within the device helps aid this coupling, as nitrate, nitrite, and ammonium ions become loosely bound/associated with surface charges on the substrate, thus helping to bring these chemical species to the bacteria which use them for carrying out nitrification and/or denitrification. More details of the nitrification/denitrification process will be provided below.

The substrate 112 provides a medium to which the bacteria's biofilm 114 can attach. The biofilm 114 forms when the device 100 is placed in the body of water 101 as naturally occurring bacteria in the body of water 101 colonize the substrate 112. In embodiments of the invention, the substrate 112 is a light expanded clay aggregate (LECA), which provides a surface area on which biofilms are formed. Also, without be bound by theory, it is believed that the LECA has a high adsorption affinity for the ammonium and is thereby conducive to the nitrification/denitrification process performed by the bacteria in biofilm 114. The LECA further provides a support for root mass of the plants 115 provided in the confinement area 104. Additionally, it is believed that a LECA substrate provides heterogeneous oxygen conditions within each pebble, which may aid the coupling of aerobic nitrification and anaerobic denitrification as each pebble can internally provide oxygen gradients by which the products of nitrification can become the reactants in denitrification. Those skilled in the art will recognize alternatives to LECA that could be used as the substrate in other embodiments of the invention. For example, gravel, perlite, coconut coir, rockwool, expanded shale, wood chips, biochar, organic materials, and synthetic materials could alternatively or in combination be used as the substrate 112. As apparent from the descriptions herein, the substrate in the device may include more than one type of material, e.g., a combination of LECA and organic materials.

Plants 115 are provided as a carbon structure in the confinement area 104. The root mass of the plants provide a source of carbon, which aids in the growth of the bacteria in the biofilm 114. The plants 115 also add a natural decorative aspect to the device 100. Still further, the plants could be edible or otherwise useful, thereby providing even further benefits stemming from the device 100.

In other embodiments of the invention, the carbon structure could take other forms. For example, the carbon structure could be specific compounds added to the confinement area 104, such as methanol, acetic acid, formic acid, ethanol, waste organic matter, and synthetic carbon substrates. As evident from the disclosure herein, the term “carbon structure” encompasses a variety of sources of carbon for the bacteria of the biofilm 114.

The device 100 is provided with a system for pumping water into the confinement area 104 and removing water from the confinement area 104. In embodiments of the invention, the water addition/removal system includes a pump 106 and a drain 116. As will be described below with respect to a method according to embodiments of the invention, the pump 106 and drain 116 may be configured to provide for a first period of time in which water is actively pumped into and removed from the confinement area 104, and a second period of time in which water is stagnant in the confinement area 104.

In embodiments of the invention, the pump 106 is power by a solar panel 108 that is positioned either on the device 100 or adjacent to the device 100. By using solar energy to power the pump 106, a natural circadian rhythm is brought about in the operation of the pump 106-the pump 106 is activated during the day and inactive at night. Such natural intermittent activity of the solar-powered pump 106 facilitates the water pumping/removal and stagnant water parts of the nitrification/denitrification method described below.

The pump 106 is attached to the platform 102 and draws water through an intake pipe 105 having a debris filter 110 that is provided in the body of water 101 in which the device 100 is floating. The length of the pipe 105 can be varied to draw the water from different depts of the body of water 101. For example, in some cases it may be useful to have a longer pipe 105 to draw water from greater depths. A longer pipe may promote more circulation in the body of water, thereby reducing undesirable anerobic conditions within the body of water. Further, often there is more nitrogen pollution towards the bottom of the body of water, and, thus, a longer pipe will draw more nitrogen pollution to the device 100 for removal.

In other embodiments, the pump 106 may be powered by means other than solar energy. For example, the pump 106 can be battery-powered. In such an embodiment, a programmable timer can be included such that the pump 106 is periodically operated in manner similar to the intermittent activity of a solar-powered pump. The pump 106 itself, whether powered by solar energy, a battery, or another source, can be different types. For example, the pump 106 may have a centrifugal, positive displacement, or jet configuration to provide the flow of water into the confinement area 104.

The drain 116 is configured to periodically allow water to be discharged from the confinement area 104 and out of the device 100 through the outtake pipe 118. In some embodiments of the invention, the drain 116 is passive in that it only relies on gravity to cause the flow of water out of the confinement area 104. In specific embodiments of the invention, the drain 116 is a bell siphon. Such a drain includes a vertical standpipe and a bell-shaped chamber. Water enters the bell siphon through an inlet near the bottom of the confinement area 104, where it fills the bell-shaped chamber. As the water level rises, it eventually reaches a height where it flows over the top of the standpipe and begins to create a siphon. Once the siphon is initiated, it drains water from the confinement area 104, creating a vacuum in the chamber that breaks the siphon and allows the confinement area 104 to refill with water pumped in from the water body 101. This cycle of filling and draining thereby repeats automatically when the pump 106 is operating. The bell siphon operates solely on the principles of gravity and hydraulic pressure, making it a simple yet effective tool for managing water flow out of the device 100.

In alternative embodiments, other types of passive draining systems may be used. For example, standpipe and overflow, u-tube siphon, p-trap drainage systems could be used with the device 100. In still other embodiments, an active draining system, such as a pump, may be used to remove the water from the confinement area 104.

With the combination of the pump 106 and the drain 116, water may be moved into and out of the confinement area 102. In particular, with a bell siphon drain 116, water may be pumped into the confinement area 102 by the pump 106 until a maximum water level 124 is reached. At this point, the siphon in the bell siphon drain 116 is initiated, and the water is drained from the confinement area 104. Other types of drains may also be configured to provide for the maximum water level 124 and subsequent draining.

Figure shows a flow chart of a method according to embodiments of the invention. The method 200 may be performed using a device as described herein.

At step 202, the device is deployed on a body of water that contains nitrogen pollution, e.g., the device is released from the shore of the body of water or from a boat in the body of water. This step is possible because of the configuration of the device, which, unlike prior art nitrogen pollution removal systems, does not require the device to be substantial in size or permanently fixed at a specific location.

At step 204, if the pump of the device is energized, it starts pumping water from the body of water into the device at step 206. The pump may be solar powered as discussed above or may be powered by a different source of energy as also discussed above. The water level in the device thereby rises until a maximum water level is reached. Water is then discharged from the device by the passive drain system at step 208, e.g., the siphon of the bell siphon drain is initiated. Note that steps 206 and 208 will often occur at the same time as water is pumped into the device while the water is drained from the device.

During steps 206 and 208, nitrification of nitrogen pollution in the water pumped into the device takes place. In particular, the biofilm formed on the substrate in the device performs nitrification to convert at least one of ammonia and ammonium in the water into nitrite and nitrate. The nitrification process occurs under aerobic conditions and is thereby facilitated by the water moving into and out of the device. That is, the moving water creates aeration (introduction of oxygen) within the device, which is conducive to the nitrification process performed by the biofilm.

If the pump is not activated in step 204, then water is stagnant with the device at step 210, for example, at the maximum water level below the point where the passive drain system is activated to discharge water. During this time, at first, oxygen within the stagnant water is consumed by the heterotrophic biological activity in the device. After the oxygen is consumed, an anoxic/anerobic environment is created within the device. The anerobic condition facilitates the denitrification process of the biofilm of converting the nitrite and nitrate and into nitrogen gas.

Through the repetition of steps 204, 206, and 208, nitrogen pollution from a water body can be removed. After a desired number of cycles of steps 204, 206, and 208 are competed, the device can be removed from the body of water at step 212. Once again, this step is facilitated by the configuration of the device, which does not require the device to be permanently fixed at a specific location. The device could thereby easily be moved to another location on the body of water, moved to a different body of water, serviced, stored, etc.

As discussed above, the lengths of a first period in which steps 206 and 208 are performed and the length of a second period in which step 210 is performed may be based on solar energy that is available to power the water pump. During sunny conditions in the daytime, the water pump will be energized and will therefore pump water into the device. At this time water is also intermittently released from the device through the passive draining system. During nighttime or other times when there is little or no sunlight, the water pump will not be active. Water therefore stagnates in the device, e.g., at a level just below the maximum level in which a bell siphon provided as the drain is activated. In such embodiments, it is therefore not necessary for a user to specifically delineate the timings of the water movement/water stagnation. However, as discussed above, in other embodiments, the device can be configured to allow the user to program specific timings for the water movement/water stagnation, e.g., by using a programmable, battery-operated water pump.

As described above, in embodiments of the invention, a two-step process occurs wherein the formed biofilm on the substrate in the device performs nitrification to convert at least of ammonium and ammonia in the water into nitrite and nitrate, and the formed biofilm subsequently converts the nitrite and nitrate into gaseous nitrogen via denitrification. Additional embodiments of the invention provide variations of the process. For example, in one embodiment the biofilm may be such that nitrite and nitrate in the water are converted into gaseous nitrogen via denitrification, but the biofilm is such that little or no ammonium and/or ammonia are nitrified into nitrite and nitrate. In another embodiment, the biofilm is such that at least one of ammonium and ammonia in the water are nitrified into nitrite and nitrate, but the biofilm is such that the nitrite and nitrate are not denitrified into nitrogen gas. Nitrate and nitrite may be considered less pollutive than ammonium and ammonia, and, thus, such an embodiment provides for reduction in nitrogen pollution even without the denitrification of the nitrate and nitrite.

In further embodiments of the invention, additional functionalities may be provided to the device and method. In one such embodiment, a phosphorus pollution treatment system can be included in the confinement area of the device. Such a treatment system might include, for example, one or more of aluminum-based coagulants (e.g., alum), iron-based coagulants (e.g., ferric chloride), calcium-based compounds (e.g., lime), polymeric metal hydroxides, adsorbents (e.g., activated alumina), biological treatments, chitin-based compounds, and lanthanum-based compounds. In still further embodiments of the invention, the device is provided with only the phosphorous pollution treatment system and not include a nitrogen pollution treatment system (e.g., a nitrogen pollution removing biofilm is not formed on a substrate in the device).

Embodiments of the invention provide benefits in addition to pollution removal. For example, embodiments of the invention may provide ecological benefits such as the device being a basking platform for pond fauna (e.g., turtles and birds), as well as providing a space where pollinator-friendly and native flora can be grown to further bolster wildlife.

Those skilled in the art will appreciate the numerous advantages provided by embodiments of the invention as compared to the prior art. The configurations of the device according to embodiments of the invention make it easily deployable in and removable from any body of water. This is a significant advantage over prior art nitrogen pollution removal systems, which are often large-scale structures permanently fixed at a location in a waterbody. Further, the device is easily scalable to provide for varying amounts of nitrogen pollution removal required by different sized water bodies. At the same time, the configuration makes it easy to deploy multiple devices within a body of water. What is more, the nature of the parts of the device, such as a solar-powered water pump and a bell siphon, make the device durable as compared to the prior art nitrogen pollution removal systems, which often include complicated parts and structures that may require frequent servicing and repair.

The terminology used in the description of the invention herein is for the purpose of describing particular implementations only and is not intended to be limiting of the invention. As used in the description of the invention and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

The foregoing description, for purpose of explanation, has been described with reference to specific implementations. However, the illustrative discussions above are not intended to be exhaustive or to limit the invention to the precise forms disclosed. Many modifications and variations are possible in view of the above teachings. The implementations described herein were chosen and described in order to best explain the principles of embodiments of the invention and its practical applications, to thereby enable others skilled in the art to best utilize embodiments of the invention and various implementations with various modifications as are suited to the particular use contemplated.

1. A device for removing nitrogen pollution from a body of water, the device comprising:
a platform configured to be released into and float on the body of water, the platform including a confinement area that is at least partially open at a top side of the device when the device is floating on the body of water;
a pump connected to the platform, the pump being configured to pump water into the confinement area during a first period, and the pump being configured to not pump water into the confinement area during a second period;
a drain positioned in the platform and configured to intermittently release water out of the confinement area;
a substrate provided in the confinement area, the substrate being configured to allow for the formation of a biofilm on the substrate; and
wherein, the pump and drain are configured such that during the first period, water is moved into the confinement area by the pump and out of the confinement area through the drain, and the formed biofilm performs nitrification to convert at least one of ammonium and ammonia in the water into nitrite and nitrate, and
wherein, the pump and drain are configured such that during the second period, water is stagnant in the confinement area and the formed biofilm converts the nitrite and nitrate into gaseous nitrogen via denitrification.

2. A device according to claim 1, further comprising a carbon structure provided in the substrate in the confinement area, the carbon structure providing a carbon source for bacteria of the biofilm.

3. A device according to claim 2, wherein the carbon structure is at least one living plant.

4. A device according to claim 1, wherein the water pump is solar powered.

5. A device according to claim 1, wherein the drain is a bell siphon.

6. A device according to claim 1, wherein the substrate includes light expanded clay aggregate (LECA).

7. A device according to claim 1, further comprising an anchor that can be deployed to temporarily fix the device at a location on the body of water.

8. A device according to claim 1, further comprising a phosphorus abatement compound provided in the confinement area.

9. A device according to claim 1, further comprising at least one drum positioned below the confinement area, the at least one drum being buoyant.

10. A device according to claim 1, wherein the platform is configured to be released into and removed from the water body.

11. A method of removing nitrogen pollution from a body of water, the method comprising:
releasing a floating device on the body of water;
pumping water from the body of water into the floating device during a first period;
draining water from the floating device during the first period;
allowing a water to stagnate in the floating device during a second period,
wherein, during the first period, a biofilm in the device performs nitrification to convert at least one of ammonia and ammonium in the water into nitrite and nitrate, and
wherein, during the second period, the biofilm converts the nitrite and nitrate into gaseous nitrogen.

12. A method according to claim 11, wherein solar energy is used to pump the water into the device.

13. A method according to claim 11, wherein the water is drained from the device using a bell siphon.

14. A method according to claim 11, further comprising removing the floating device from the water body at a time after the second period.

15. A device for removing nitrogen pollution from a body of water, the device comprising:
a platform configured to be released into and float on the body of water, the platform including a confinement area that is at least partially open at a top side of the device when the device is floating on the body of water;
a pump connected to the platform, the pump being configured to pump water into the confinement area during a first period, and the pump being configured to not pump water into the confinement area during a second period;
a drain positioned in the platform and configured to intermittently release water out of the confinement area;
a substrate provided in the confinement area, the substrate being configured to allow for the formation of a biofilm on the substrate; and
wherein, the pump and drain are configured such that during the first period, water is moved into the confinement area by the pump and out of the confinement area through the drain;
wherein, the pump and drain are configured such that during the second period, water is stagnant in the confinement area and the formed biofilm converts nitrite and nitrate in the stagnant water into gaseous nitrogen via denitrification.

16. A device for removing nitrogen pollution from a body of water, the device comprising:
a platform configured to be released into and float on the body of water, the platform including a confinement area that is at least partially open at a top side of the device when the device is floating on the body of water;
a pump connected to the platform, the pump being configured to pump water into the confinement area during a first period, and the pump being configured to not pump water into the confinement area during a second period;
a drain positioned in the platform and configured to intermittently release water out of the confinement area;
a substrate provided in the confinement area, the substrate being configured to allow for the formation of a biofilm on the substrate; and
wherein, the pump and drain are configured such that during the first period, water is moved into the confinement area by the pump and out of the confinement area through the drain, and the formed biofilm performs nitrification to convert at least one of ammonium and ammonia in the water into nitrite and nitrate.
